(19) United States
(12) Patent Application Publication
(10) Pub. No.: US 2005/0256845 A1
(43) Pub. Date: Nov. 17, 2005

(54) Data management for a networked multimedia console

(75) Inventors: James H. Jen, Redmond, WA (US); Gary Alan Thompson, Redmond, WA (US); Daniel M.C. Caiafa, Redmond, WA (US); Brent Edward Curtis, Bellevue, WA (US); Boyd Cannon Multerer, Seattle, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/842,211

(22) Filed: May 10, 2004

(51) Int. Cl. G06F 17/30

(52) U.S. Cl. 707/3

(57) ABSTRACT

A system and method provides for managing data accessible by multimedia consoles that execute a multimedia application. The system includes a database that stores data for the multimedia consoles. The system also includes a storage manager that communicates between the multimedia consoles and the database. The system further includes a storage configuration database that stores access permission information for the database. In determining whether to grant the request, the system uses the access permission information from the storage configuration database. This abstraction of access permission information from the databases themselves to the storage configuration database may provide flexibility in managing the databases.

### FIELD OF THE INVENTION

The invention generally relates to the field of multimedia consoles. In particular, the invention relates to systems and methods for data management for a networked multimedia console.

### BACKGROUND OF THE INVENTION

Traditionally, multimedia consoles (e.g., gaming systems) accommodated a limited number of players, such as 1-4 players, that remain local to the multimedia console. A recent trend in multimedia console gaming systems is to provide capabilities to facilitate gaming among multiple players over a network, such as Internet-based online gaming. These online gaming systems allow players to compete with other players, regardless of their geographic location. This online networking of multimedia consoles may provide capabilities beyond competing with geographically disparate players. For example, one online feature provides incentives for players to continue playing a particular game by maintaining online statistics, such as top scores for a particular game. This allows players to compete for “bragging rights” amongst the world's top players or amongst their friends. These online gaming systems, however, have not fully leveraged the network capability of multimedia consoles. Therefore, there is a need for better utilizing the network capability of accessing multimedia console-related data via a network.

### SUMMARY OF THE INVENTION

The invention is directed to a system and method for managing data accessible by multimedia consoles that execute a multimedia application. The system includes a database that stores data for the multimedia consoles. The system also includes a storage manager that communicates between the multimedia consoles and the database. The system further includes a storage configuration database that stores access permission information for the database. In determining whether to grant the request, the system uses the access permission information from the storage configuration database. This abstraction of access permission information from the databases themselves to the storage configuration database may provide flexibility in managing the databases.

Additional features of the invention will be made apparent from the following detailed description of illustrative embodiments that proceeds with reference to the accompanying drawings.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings illustrative embodiments of the invention; however, the invention is not limited to the specific methods and instrumentalities disclosed. In the drawings:

FIG. 1 is a block diagram showing an exemplary multimedia console with which aspects of the invention may be implemented;

FIG. 2 is a block diagram showing an illustrative data center networked with exemplary multimedia consoles, in accordance with an aspect of the invention;

FIG. 3 is a block diagram showing an further illustrative details of the illustrative data center of FIG. 2, in accordance with an aspect of the invention;

FIG. 4 is a block diagram showing an further illustrative details of the illustrative data center of FIG. 2 and illustrative addresses for referencing portions of the illustrative data center, in accordance with an aspect of the invention;

FIG. 5 is a flowchart of an illustrative method for accessing data of the illustrative data center, in accordance with an aspect of the invention; and

FIG. 6 is a flowchart showing further illustrative details of the illustrative method of FIG. 5, in accordance with an aspect of the invention; and

FIG. 7 is a block diagram showing further illustrative details of the data center of FIG. 2, in accordance with an aspect of the invention.

### DETAILED DESCRIPTION OF ILLUSTRATIVE EMBODIMENTS

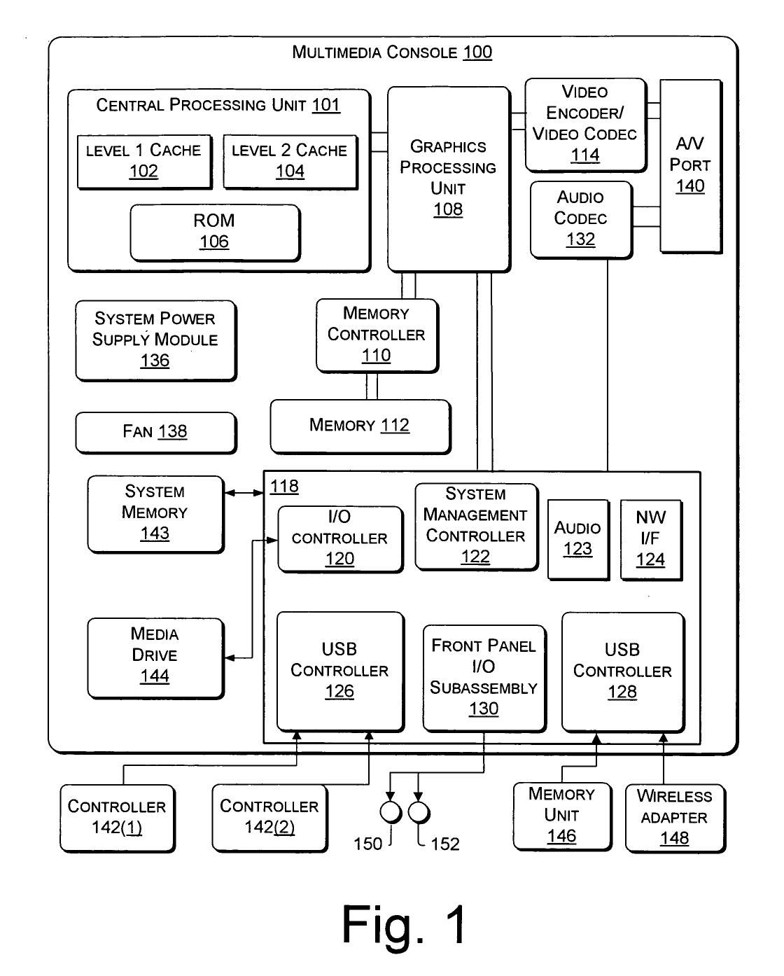

FIG. 1 illustrates the functional components of a multimedia console 100 with which aspects of the invention may be implemented. The multimedia console 100 has a central processing unit (CPU) 101 having a level 1 (L1) cache 102, a level 2 (L2) cache 104, and a flash ROM (Read-only Memory) 106. The L1 cache 102 and L2 cache 104 temporarily store data and hence reduce the number of memory access cycles, thereby improving processing speed and throughput. The flash ROM 106 may store executable code that is loaded during an initial phase of a boot process when the multimedia console 100 is powered.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2) (such as, for example, a gamepad controller, and the like), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through network interface 124 or the wireless adapter 148, the multimedia console 100 may further be operated as a participant in a larger network community, such as described in more detail below.

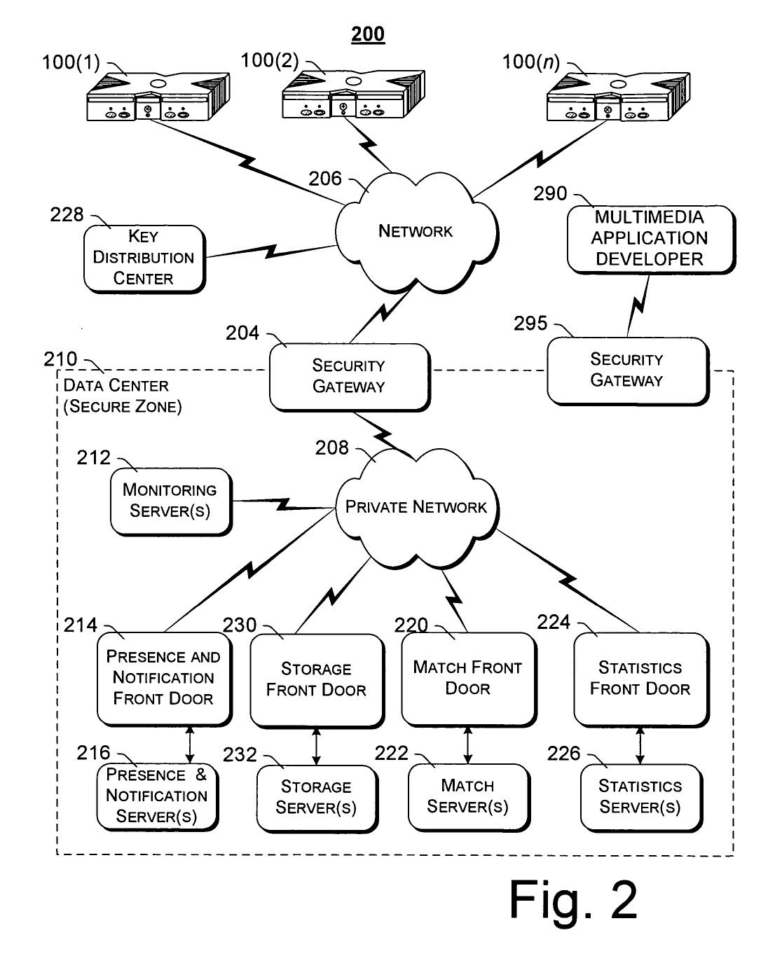

FIG. 2 is a block diagram of an exemplary online networked multimedia (e.g, gaming) environment 200. As shown in FIG. 2, multiple multimedia consoles 100(1), 100(2), . . . , 100(n) are coupled to a security gateway 204 via a network 206. Network 206 represents any one or more of a variety of data communications networks. Network 206 typically includes packet switched networks, but may also include circuit switched networks. Network 206 may include wired and/or wireless portions. In one exemplary implementation, network 206 includes the Internet and may optionally include one or more local area networks (LANs) and/or wide area networks (WANs). When implemented in a LAN networking environment, multimedia console 100 may be connected to a LAN via network interface 124. When implemented in a WAN networking environment, multimedia console 100 may include a modem or other means for establishing communications over the WAN. The described network connections are illustrative only and other means of establishing communication link(s) between the multimedia consoles 100 may be implemented. Typically, at least a part of network 206 is a public network, which refers to a network that is publicly-accessible.

Security gateway 204 operates as a gateway between public network 206 and private network 208. Private network 208 can be any of a wide variety of networks, such as, for example, a local area network, a wide area network, and the like. Private network 208, as well as other devices discussed in more detail below, is within a data center 210 that operates as a secure zone. Data center 210 is made up of trusted devices communicating via trusted communications. Thus, encryption and authentication within secure zone 210 is not typically utilized. The private nature of network 208 refers to the restricted accessibility of network 208—access to network 208 is restricted to only certain individuals (e.g., restricted by the owner or operator of data center 210).

Security gateway 204 may be a cluster of one or more security gateway computing devices. These security gateway computing devices may collectively implement security gateway 204. Security gateway 204 may optionally include one or more conventional load balancing devices that operate to direct requests to be handled by the security gateway computing devices to appropriate ones of those computing devices. This directing or load balancing is performed in a manner that attempts to balance the load on the various security gateway computing devices approximately equally (or alternatively in accordance with some other criteria).

Also within data center 210 are: one or more monitoring servers 212; one or more presence and notification front doors 214, one or more presence and notification servers 216 (or separate servers individually implementing a presence and notification service in combination with presence and notification front door 214); one or more match front doors 220 and one or more match servers 222 (collectively implementing a match service); one or more statistics front doors 224 and one or more statistics servers 226 (collectively implementing a statistics service); and one or more storage front doors 230 and one or more storage servers 232 (collectively implementing a storage service). The servers 216, 222, 226, and 232 provide services to multimedia consoles 100, and thus can be referred to as service devices. Other service devices may also be included in addition to, and/or in place of, one or more of the servers 216, 222, 226, and 232. Although only one data center is shown in FIG. 2, multiple data centers may exist with which multimedia consoles 100 can communicate. These data centers may operate independently or alternatively may operate collectively (e.g., to make one large data center available to multimedia consoles 100). Further, any or all of the services of data center 210 may be geoscaled, such that there may be one service providing service in each of a plurality of regional data centers 210.

Multimedia consoles 100 are situated remotely from data center 210, and access data center 210 via network 206. A multimedia console 100 desiring to communicate with one or more devices in data center 210 establishes a secure communication channel between the console 100 and security gateway 204. Multimedia console 100 and security gateway 204 encrypt/decrypt and authenticate data packets being passed back and forth, thereby allowing the data packets to be securely transmitted between them without being understood by other devices that may capture or copy the data packets without breaking the encryption. Each data packet communicated from multimedia console 100 to security gateway 204, or from security gateway 204 to multimedia console 100 can have data embedded therein. This embedded data is referred to as the content or data content of the packet. Additional information may also be inherently included in the packet based on the packet type (e.g., a heartbeat packet, a traversal packet, and the like).

The secure communication channel between a console 100 and security gateway 204 may be based on a security ticket. To implement such a security ticket based channel, multimedia console 100 may authenticates itself and the current user(s) of multimedia console 100 to a key distribution center 228 and obtain, from key distribution center 228, a security ticket. Console 100 then uses this security ticket to establish the secure communication channel with security gateway 204.

In establishing the secure communication channel with security gateway 204, the multimedia console 100 and security gateway 204 authenticate themselves to one another and establish a session security key that is known only to that particular multimedia console 100 and the security gateway 204. This session security key is used as a basis to encrypt/decrypt data transferred between the multimedia console 100 and the security gateway 204, so no other devices (including other multimedia consoles 100) can read the data. The session security key is also used as a basis to authenticate a data packet as being from the security gateway 204 or multimedia console 100 that the data packet alleges to be from. Thus, using such session security keys as a basis, secure communication channels can be established between the security gateway 104 and the various multimedia consoles 100.

Once the secure communication channel is established between a multimedia console 100 and security gateway 204, encrypted data packets can be securely transmitted between them. When the multimedia console 100 desires to send data to a particular service device in data center 210, the multimedia console 100 encrypts the data and sends it to security gateway 204 requesting that it be forwarded to the particular service device(s) targeted by the data packet. Security gateway 204 receives the data packet and, after authenticating and decrypting the data packet, encapsulates the data content of the packet into another message to be sent to the appropriate service via private network 208. Security gateway 204 determines the appropriate service for the message based on the requested service(s) targeted by the data packet.

Similarly, when a service device in data center 210 desires to communicate data to a multimedia console 100, the service device sends a message to security gateway 204, via private network 208, including the data content to be sent to the multimedia console 100 as well as an indication of the particular multimedia console 100 to which the data content is to be sent. Security gateway 204 embeds the data content into a data packet, and then encrypts the data packet so it can only be decrypted by the particular multimedia console 100 and also authenticates the data packet as being from the security gateway 204.

Although discussed herein as primarily communicating encrypted data packets between security gateway 204 and a multimedia console 100, alternatively some data packets may be partially encrypted (some portions of the data packets are encrypted while other portions are not encrypted). Which portions of the data packets are encrypted and which are not encrypted, can vary based on the desires of the designers of data center 210 and/or multimedia consoles 100. For example, the designers may choose to allow voice data to be communicated among consoles 100 so that users of the consoles 100 can talk to one another—the designers may further choose to allow the voice data to be unencrypted while any other data in the packets is encrypted. Additionally, some data packets may have no portions that are encrypted (that is, the entire data packet is unencrypted). It should be noted that, even if a data packet is unencrypted or only partially encrypted, the data packet is typically still authenticated.

Each security gateway device in security gateway 204 is responsible for the secure communication channel with one or more multimedia consoles 100, and thus each security gateway device can be viewed as being responsible for managing or handling one or more multimedia consoles. The various security gateway devices may be in communication with each other and communicate messages to one another. For example, a security gateway device that needs to send a data packet to a multimedia console that it is not responsible for managing may send a message to all the other security gateway devices with the data to be sent to that multimedia console. This message is received by the security gateway device that is responsible for managing that multimedia console and sends the appropriate data to that multimedia console. Alternatively, the security gateway devices may be aware of which multimedia consoles are being handled by which security gateway devices—this may be explicit, such as each security gateway device maintaining a table of multimedia consoles handled by the other security gateway devices, or alternatively implicit, such as determining which security gateway device is responsible for a particular multimedia console based on an identifier of the multimedia console.

Monitoring server(s) 212 operate to inform devices in data center 210 of an unavailable multimedia console 100 or an unavailable security gateway device of security gateway 204. Multimedia consoles 100 can become unavailable for a variety of different reasons, such as a hardware or software failure, the console being powered-down without logging out of data center 210, the network connection cable to console 100 being disconnected from console 100, other network problems (e.g., the LAN that the console 100 is on malfunctioning), etc. Similarly, a security gateway device of security gateway 204 can become unavailable for a variety of different reasons, such as hardware or software failure, the device being powered-down, the network connection cable to the device being disconnected from the device, other network problems, etc.

Each of the security gateway devices in security gateway 204 is monitored by one or more monitoring servers 212, which detect when one of the security gateway devices becomes unavailable. In the event that a security gateway device becomes unavailable, monitoring server 212 sends a message to each of the other devices in data center 210 (servers, front doors, etc.) that the security gateway device is no longer available. Each of the other devices can operate based on this information as it sees fit (e.g., it may assume that particular multimedia consoles being managed by the security gateway device are no longer in communication with data center 210 and perform various clean-up operations accordingly). Alternatively, only certain devices may receive such a message from the monitoring server 212 (e.g., only those devices that are concerned with whether security gateway devices are available).

Security gateway 204 monitors the individual multimedia consoles 100 and detects when one of the multimedia consoles 100 becomes unavailable. When security gateway 204 detects that a multimedia console is no longer available, security gateway 204 sends a message to monitoring server 212 identifying the unavailable multimedia console. In response, monitoring server 212 sends a message to each of the other devices in data center 210 (or alternatively only selected devices) that the multimedia console is no longer available. Each of the other devices can then operate based on this information as it sees fit.

Presence and notification server(s) 216 store and process data concerning the status or presence of a given user logged in to data center 210 for online gaming. Presence and notification server(s) 216 further maintains multiple queues of outgoing messages destined for a player logged in to data center 210. Presence and notification front door 214 is one or more server devices that operate as an intermediary between security gateway 204 and server 216. One or more load balancing devices (not shown) may be included in presence and notification front door 214 to balance the load among the multiple server devices operating as front door 214. Security gateway 204 communicates messages for server 216 to the front door 214, and the front door 214 identifies which particular server 216 the message is to be communicated to. By using front door 214, the actual implementation of servers 216, such as which servers are responsible for managing data regarding which users, is abstracted from security gateway 204. Security gateway 204 can simply forward messages that target the presence and notification service to presence and notification front door 214 and rely on front door 214 to route the messages to the appropriate one of server(s) 216.

Match server(s) 222 store and process data concerning the matching of online players to one another. An online user is able to advertise a game available for play along with various characteristics of the game (e.g., the location where a football game will be played, whether a game is to be played during the day or at night, the user's skill level, etc.). These various characteristics can then be used as a basis to match up different online users to play games together. Match front door 220 includes one or more server devices (and optionally a load balancing device(s)) and operates to abstract match server(s) 222 from security gateway 204 in a manner analogous to front door 214 abstracting server(s) 116.

Statistics server(s) 226 store and process data concerning various statistics for multimedia consoles (e.g., online games). The specific statistics used can vary based on a game designer's desires (e.g., the top ten scores or times, a world ranking for all online players of the game, a list of users who have found the most items or spent the most time playing, etc.). Statistics front door 226 includes one or more server devices (and optionally a load balancing device(s)) and operates to abstract statistics server(s) 226 from security gateway 204 in a manner analogous to front door 214 abstracting server(s) 216.

Storage server(s) 232 store and process data concerning various aspects of multimedia consoles (e.g., online games), described in more detail below. Storage front door 230 includes one or more server devices (and optionally a load balancing device(s)) and operates to abstract storage server(s) 232 from security gateway 204 in a manner analogous to front door 214 abstracting server(s) 216.

The storage server data can be managed on a per multimedia application title basis (“title-based management”), on a per user basis (“user-based management”), or some combination thereof, described in more detail below. Title based management is based on a per-multimedia application title basis. For example, a multimedia application title may be “Race Car Driver.” In this case, the various multimedia applications titled “Race Car Driver” that are executing on multimedia consoles 100 manage and interact with a particular portion of storage server(s) 232. For user-based management, the various multimedia applications, of any title, may allow a user to interact with a particular portion of storage server(s) 232. With such title-based management and user-based management, multimedia application publishers (e.g., game publishers) may provide enhanced features to gamers, such as, for example, a custom user emblem, a custom team emblem, a gaming condition for a particular time (e.g., a football game application may access weather conditions from storage server(s) 232), and the like. Further, users may share data with other users, such as, for example, messages, new skate parks for a skateboard gaming application, and the like.

In more detail, when storage front door 230 gets a request, storage front door 230 analyzes the request to determine how to process the request. For example, the request may include a path field that includes namespace levels or hierarchies that correspond to a particular location, database, or portion of a database of storage server(s) 232 (and may also correspond to a particular data center 210). In such a case, storage front door 230 may analyze the path field and determine if the request has ended up in the wrong location (e.g., if storage front door 230 does not have access to the requested path). Storage front door 230 may make such determination by knowing that one of the namespace levels in the path field does not exist in its service. If so, storage front door 230 may return some well-known “REDIRECT” error message to the multimedia console 100 or other client for proper handing by the multimedia console 100 or other client.

Storage front door 230 may further determine routing through the various data hierarchies of the databases of storage server(s) 232 via the use of pathnames (e.g., in a path field of a request). The schema of such pathnames may support such routing by allowing paths of arbitrary lengths, as described in more detail below. The storage front door 230 may determine which database to access by a domain portion of a pathname (e.g., “stats,” “msg,” etc), or it may resolve the path more fully, as described in more detail below.

Thus, it can be seen that security gateway 204 operates as in interface to various services of data center 210. Security gateway 204 also operates to shield devices in the secure zone of data center 210 from the untrusted, public network 206. Communications within the secure zone of data center 210 are typically not encrypted, as all devices within data center 210 are trusted. However, any information to be communicated from a device within data center 210 to a multimedia console 100 passes through security gateway cluster 204, where it is encrypted in such a manner that it can be decrypted by only the multimedia console 100 targeted by the information.

Data center 210 may include a second security gateway 295 for access by multimedia application publisher client 290. Security gateway 295 may also operate to shield devices in the secure zone of data center 210. Security gateway 295, however, may allow a different set of permissions. For example, security gateway 295 may be accessed only by trusted sources, such as, for example, multimedia application publisher client 290. As such, security gateway 295 may allow multimedia application publisher client 290 to write data to a Title-managed database, described in more detail below. In this manner, a multimedia application publisher (e.g., a game publisher) may be granted access to write snowy weather conditions for a football game set in Green Bay, Wis. and to write warm weather conditions for a football game set in Miami, Fla.

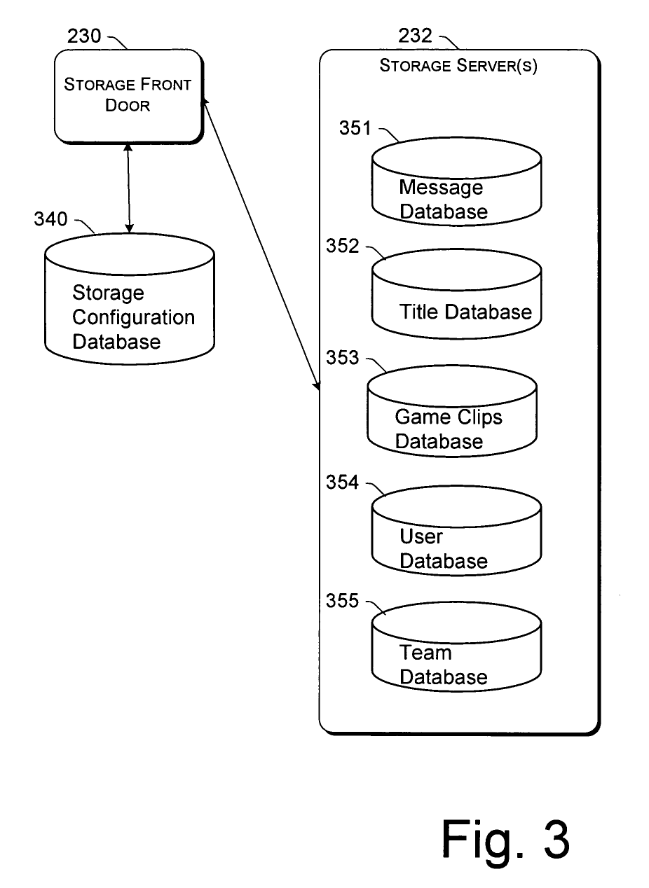

FIG. 3 shows further illustrative details of data center 210 of FIG. 2. As shown in FIG. 3, storage server(s) 232 may include multiple databases. The multiple databases may be stored on a single server, stored on multiple servers, distributed among multiple servers, and the like. As shown, storage server(s) 232 includes a message database 351, a title database 352, a game clip database 353, a user database 354, and a team database 355. Storage server(s) 232 can, however, include various other databases for use by multimedia applications and multimedia applications users.

Message database 351 may be a user managed database and may store and enable the processing of message attachments between users of various multimedia applications having different titles. Message database 351 may store message attachments that are associated with messages between multimedia application users. In this manner, users of different multimedia application titles may still communicate messages with each other. As such, users playing different games may still be able to send each other voice-mails, e-mails, etc.

Title database 352 may be a title managed database and may store information on a per-title basis. In this manner, users of a particular multimedia application title may share data generated by the multimedia application title publisher. For example, a game publisher may create a football game application and post weather conditions to storage server(s) 232 for use in scheduled multi-user football games. In this manner, a game publisher may emulate actual weather conditions in the game application.

Game clip database 353 may be a title-managed database and may store information on a per-title basis. In this manner, users of a particular multimedia application title may share game data. For example, a game-clip may be a recorded game (also referred to as a “ghost race”, a “highlight”, a “highlight race”, or a “saved game”). A recorded game and other saved data can be downloaded and used by numerous players. Players can watch the recorded games or “ride along” during a replay of the recorded game to learn how the best players obtain their top scores. Additionally, players can compete against the recorded game to test or improve their own skills. A game clip may be, for example, a longest run in a football game, a biggest explosion, a clever golf shot, best bloopers (i.e., mistakes), and the like.

User database 354 may be a title-managed database and may store information on a per-title basis and then at a per-user basis. In this manner, users of a particular multimedia application title may share data generated by a particular user. Further, a multimedia application user may store configuration settings at data center 210 and access those setting from any multimedia console 100. For example, a user may store a “left handed” gamepad configuration in data center 210 and be able to access that configuration from any multimedia console 100. In this manner, a user can easily use a custom game configuration regardless of their location.

Team database 355 may be a title-managed database and may store information on a per-title basis. In this manner, users of a particular multimedia application title who are on the same team may share data. For example, each team member may have access to a team icon.

The databases may be implemented without requiring the multimedia applications to adopt any particular file format. In this manner, a multimedia application publisher (e.g., game publisher) may continue to use their own existing file format for their data. Further, storage server(s) 232 may treat data as “blob” data sent by the multimedia console 100 (or game publisher). Such an implementation allows multimedia application publishers to continue to use their own file format and to create new file formats in the future. The game publisher may use an Application Programming Interface (API) to communicate data with storage server(s) 232.

The “blob” data, while not tied to any particular file format may be stored in a file system or a slot system of the databases of storage server(s) 232. In an illustrative file system, storage server(s) 232 may allow each multimedia application title to store, on behalf of each user (or gamer), up to 8 files of variable size and names. Alternatively, storage server(s) 232 may allow each multimedia application title to store, on behalf of each user (or gamer), more or less than 8 files. Storage server(s) 232 may limit each user of each multimedia application title to a 64 KB quota or other quotas, such as, for example, 30 KB. Alternatively, storage server(s) 232 may limit each user of each multimedia application title to a limit greater or less than 30 KB. With the implementation of such a filing system, the multimedia application may need to manage quotas, file naming, errors from exceeding any quota, and the like.

Alternatively, the “blob” data may be stored in slot format on storage server(s) 232. For example, a multimedia application may store 8 files (or slots) on behalf of each user, each file having a maximum size of 8 KB, for a total of 64 KB per user. For example, slots 1 and 4 may contain a file that's 8 KB utilizing the entire slot, slots 2 and 3 may contain files that don't use the entire slot, slots 5 and 6 may both used to store a large file (a first portion of the large file being stored in Slot 5 and the second portion of the large file being stored in slot 6).

FIG. 3 also illustrates storage configuration database 340. Storage configuration database 340 contains information related to the access permissions associated with each database of storage server(s) 232. For example, storage configuration database 340 may contain read/write permissions for each database in storage server(s) 232. In effect, storage configuration database 340 abstracts the permissions away from the databases themselves. In this manner, the databases are not burdened with the overhead of managing access permissions. Furthermore, the databases may be more easily modified.

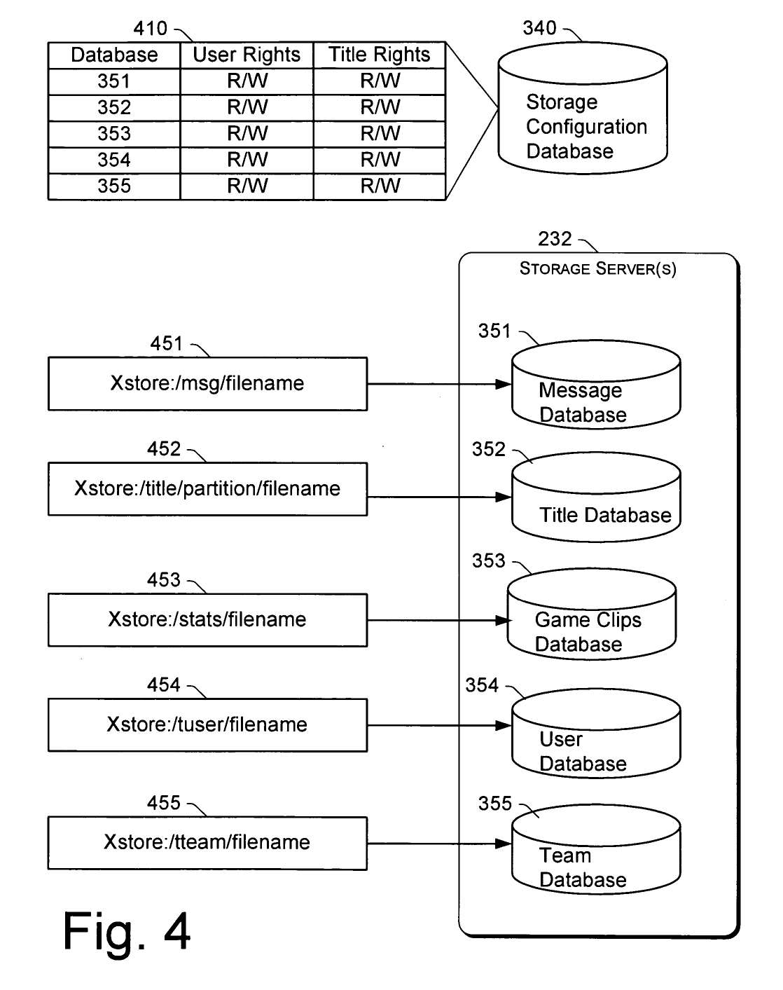

FIG. 4 shows an illustrative storage configuration 410 of storage configuration database 340. As shown, each database (e.g., database 351, 352, 353, 354, and 355) has a corresponding set of permissions. While the illustrative storage configuration 410 shows only read and write permissions for users and titles, there may be multiple permission types for different entities. For example, access permissions may include the following: None—no permission for any clients; All—permission always granted; Owner—permission granted for the owner of the file or portion of the storage area; Team—permission granted for a member of the specified team; UserToken—permission granted by an access token signed by another user; ServiceToken—permission granted by an access token signed by a multimedia application data center service; and ServiceAddr—permission granted for requests sent to back-end IP addresses.

FIG. 4 also shows pathnames that may be used with an associated request to access the various databases of storage server(s) 232. For example, pathname 451 “Xstore:/msg/filename” may be used to access message database 351, pathname 452 “Xstore:/title/partition/filename” may be used to access title database 352, pathname 453 “Xstore:/stats/filename” may be used to access game clips database 353, pathname 454 “Xstore:/tuser/filename” may be used to access user database 354, and pathname 455 “Xstore:/tteam/filename” may be used to access team database 355. Each pathname may be divided or parsed into its constituent parts. For example, pathname 451 “Xstore:/msg/filename” may be parsed into: “Xstore,” “msg,” and “filename.” “Xstore” may be associated with data center 210 and therefore indicate that the request associated with pathname 451 is addressed to data center 210. “Msg” may be associated with message database 351 and therefore indicate that the request associated with pathname 451 is addressed to message database 351 (of data center 210). “Filename” may be associated with a file or slot of message database 351 and therefore indicate that the request associated with pathname 451 is addressed to the file or slot (of message database 351 of data center 210) corresponding to “filename.”

Such abstraction into a pathname may insulate game publishers from the behind-the-scenes details of how data center 210 is partitioned, geo-located, etc., leaving the publisher free to focus on game development instead of database interface. Further, this abstraction may provide a technique for accessing physically disparate storage locations from a given client without the client needing to understand the evolving layout of data centers and databases.

This is in contrast to conventional games which are “pointed” to a specific location during logon when multimedia console 100 receives a service ticket to a game. The ticket includes the IP address of the front door machines for the service requested. The techniques described herein, rather than containing a specific IP address, the service ticket may include a pathname that can be dynamically resolved to an IP address.

To provide this dynamic resolution of pathname to IP address, a name resolution service may be provided. The name resolution service maps pathnames to real IP/port pairs. The name resolution service may support a simple macro/rule language which describes a set of rules (specified by a rule configuration file). Each incoming pathname may be subjected to each rule in turn until a match is found. Following this, the name resolution service may send the resulting port/IP pair to the client (e.g., multimedia console 100). The name resolution service may also send the client a simple version of the rule used to determine the port/IP pair. In this manner, the client can cache both the rule and the port/IP pair and attempt to subsequently intelligently resolve pathnames itself.

Table 1 shows illustrative path names. The paths are conceptual paths because the hardware may be distributed geographically, may change over time, and the like, and therefore, there is not always a one-to-one correspondence between paths and hardware, although there could be a one-to-one correspondence between paths and hardware.

TABLE 1

| Conceptual path | Description |
|---|---|
| Xstore:\ | The root of the conceptual storage location, for example, data center |
| | 210. Files at the root level are typically only accessed by the data |
| | center 210 itself, rather than by an clients accessible via network 206. |
| Xstore:\puid | The user-managed (e.g., player-managed) storage root. |
| Xstore:\puid\titleid | The user-managed storage root for a given multimedia application title. |
| | The location where files written by a given title reside. |
| Xstore:\puid\titleid\pvt | Title-managed storage space in the user's partitioned storage space. |
| | This allows a game to easily track data on a per-player basis while not |
| | requiring the user to manage storage space. Data in this space may |
| | consume the title's quota not the user's quota. |
| Xstore:\titleid | Title-managed storage root. The location where all title-wide files are |
| | stored for a given title. |

For example, a pathname to a statistics database (not shown) may be given by:
//stats.<titleid>/u:<puid>/<titleid>/<filename>

where “stats” indicates the statistics database, where “titleid” indicates a title identifier, and where “puid” indicates a user identifier. The statistics database may store information about high scores for a particular multimedia game, and the like. Such a pathname may have corresponding permissions as shown in Table 2.

TABLE 2

| Operation | Permission Type (W2) | Permission Type (W3) |
|---|---|---|
| ReadFile | ALL | ALL |
| WriteFile | ServiceToken | ServiceToken |
| RemoveFile | ServiceAddr | ServiceAddr |

The statistics database, in addition to storing information about high scores, may be used to determine whether a particular user is granted access permission to right data to a storage server(s) 232. For example, a user of a multimedia console 100 may only be granted permission to right their name or nickname to a leaderboard (or other area) if the user has one of the top ten scores.

A pathname to a title database (e.g., database storing global per-title data) may be given by:
//title.<titleid>/t:<titleid>/<filename>.

Such a pathname may have corresponding permissions as shown in Table 3.

TABLE 3

| Operation | Permission Type (W2) | Permission Type (W3) |
|---|---|---|
| ReadFile | ALL | ALL |
| WriteFile | ALL | ServiceAddr |
| RemoveFile | ALL | ServiceAddr |

A pathname to a user database (e.g., database storing per-user, per-title data) may be given by:
//tuser.<titleid>/u:<puid>/<titleid>/<filename>

where “tuser” indicates the user database (e.g., database storing per-user, per-title data). Such a pathname may have corresponding permissions as shown in Table 4.

TABLE 4

| Operation | Permission Type (W2) | Permission Type (W3) |
|---|---|---|
| ReadFile | ALL | ALL |
| WriteFile | Owner | Owner |
| RemoveFile | Owner | Owner |

A pathname to message database 351 may be given by:
//msg.<country-id>/u:<puid>/<msg-path>

where “country-id” indicates the country from which the message was sent and “msg-path” indicates the path to the message on a message server, for example. Message database 315 may by treated as a large global space (though partitioned by puid) and all access control list (ACL) (e.g., Table 2) checks are handled by a messaging service. In this manner, one file is downloaded even if an attachment is sent to many different people. Such a pathname may have corresponding permissions as shown in Table 5.

TABLE 5

| Operation | Permission Type (W2) | Permission Type (W3) |
|---|---|---|
| ReadFile | ALL | ALL |
| WriteFile | ALL | ALL |
| RemoveFile | ALL | ALL |

A pathname to team database 355 (e.g., per-title team storage) may be given by:
//tteam.<titleid>/u:<team-puid>/<titleid>/<user-puid>/<filename>

where “team-puid” indicates a unique team identification number and “user-puid” indicates a unique user identification number. Further, teams may be globally partitioned by country-id. Such a pathname may have corresponding permissions as shown in Table 6.

TABLE 6

| Operation | Permission Type (W2) | Permission Type (W3) |
|---|---|---|
| ReadFile | ALL | Team |
| WriteFile | ALL | Team |
| RemoveFile | ALL | Team |

More generally, the file pathname may be given by:
//<domain>/<key_type>:<key>/<path_name>. The “domain” portion may be used by the system to: (a) determine which cluster of databases or even which datacenter the file resides on (e.g., a datacenter associated with “Xstore” and (b) determine what access permissions are enforced for the request. In this manner, support for completely different types of applications (e.g. Stats, Messaging, Title-storage, and the like) can more easily be added by creating a domain for each application and setting the desired access control parameters for each one. The “key_type” and “key” portions may used to identify a particular server in the cluster determined by <domain>. Similarly, the this manner, new applications don't require changes to the service infrastructure. In contrast, simple configuration changes suffice to implement a new application.

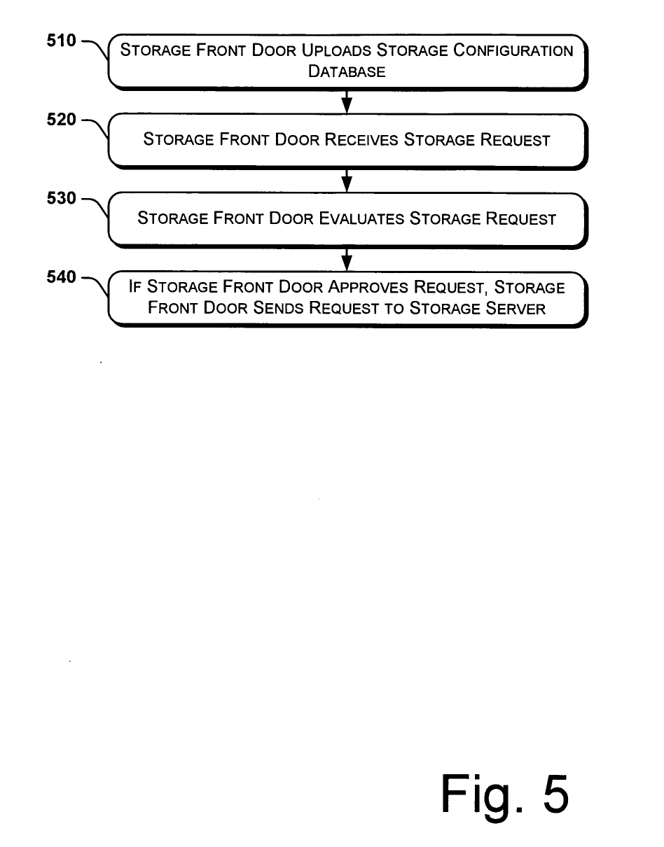

FIG. 5 shows an illustrative method for accessing data, for example, from data center 210. As shown in FIG. 5, at step 510, storage front door 230 downloads a configuration from storage configuration database 340. The configuration includes permissions for databases (e.g., databases 351-355), allowing storage front door 230 to appropriately process requests to communicate with the databases of storage server(s) 232. The configuration may be, for example, configuration 410, Tables 1-6, or the like. Alternatively, storage front door 230 may download a configuration upon each request to communicate with the databases of storage server(s) 232, upon some regular interval, upon receiving a command to upload the configuration, or the like.

At step 520, storage front door 230 receives a request to communicate with the databases of storage server(s) 232. For example, storage front door 230 may receive a request from multimedia console 100(1) to write a team icon to team database 355. In this manner, by locating the team icon in team database 355, a user can access the team icon from any multimedia console, regardless of its geographic location. That is, a user can save a team icon or a custom armor, for example, in storage server(s) 232 and be able to access the icon or armor from any multimedia console 100 (e.g., a console located at his friend's house).

At step 530, storage front door 230 evaluates the request. For example, storage front door 230 may determine a user identification, a title identification, a permission corresponding to the request, or the like and determines whether to process the request or deny the request.

At step 540, if storage front door 230 approves the request, storage front door 230 sends the request to storage server(s) 232. If there are multiple storage servers 232, storage front door 230 sends the request to the appropriate storage server 232.

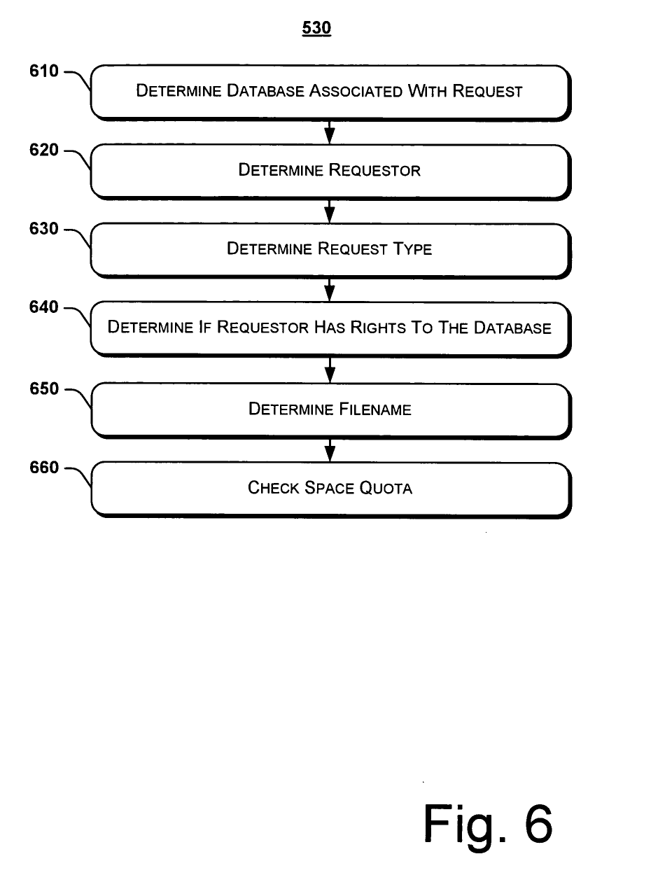

FIG. 6 shows more details of illustrative step 530. At step 610, storage front door 230 determines the database associated with the request. For example, if the request includes pathname “//tteam.<titleid>/u:<team-puid>/<titleid>/<user-puid>/<filename>,” storage front door 230 may parse the portion “tteam” from the pathname and determine therefrom that the request is directed to team database 355.

At step 620, storage front door 230 determines the requester associated with the request. For example, if the request includes pathname “//tteam.<titleid>/u:<team-puid>/<titleid>/<user-puid>/<filename>,” storage front door 230 may parse the portion “user-puid” from the pathname and determine therefrom that the request has come from a user associated with “user-puid.” Storage front door 230 may further parse the portion “team-puid” from the pathname and determine therefrom that the request has come from a user associated with “team-puid.”

At step 630, storage front door 230 determines the request type. For example, storage front door 230 may determine whether the request is a read request, write request, or the like.

At step 640, storage front door 230 determines if the requestor has requested rights to perform the requested action on the database. For example, if the request includes pathname “//tteam.<titleid>/u:<team-puid>/<titleid>/<user-puid>/<filename>,” storage front door 230 may lookup from Table 6 to determine if the requestor/team has the appropriate rights.

At step 650, storage front door 230 determines the filename associated with the request. For example, if the request includes pathname “//tteam.<titleid>/u:<team-puid>/<titleid>/<user-puid>/<filename>,” storage front door 230 may parse the portion “filename” from the pathname.

At step 660, storage front door 230 may check to determine if any space quotas are exceeded. For example, storage front door 230 may limit space to 5 MB per Title, and the per-user space at 8 kb per-user, per-title. Independent storage quotas may be managed such that each title has a different quota. In one embodiment, a multimedia application may request access to the databases of storage server(s) 232 via an API. The API may return the amount of remaining available space to the multimedia application. Therefore, a title publisher or a multimedia application will be able to determine how much space is available before uploading any data. If there isn't available space for the content, the title publisher should gracefully handle this scenario.

If a multimedia application tries to write data even after the API has notified the multimedia application that there is not sufficient space, a soft quota enforcement policy may be implemented. In this manner, the user isn't “punished” just because the title is not following the quota. In one implementation of the soft quota, the initial request for an upload that exceeds the available storage limit is not denied, but subsequent requests are denied until some storage space is freed. For example, if a title has 1 MB of storage left online and then tries to upload a 7 MB file, storage front door 230 may allow the upload of the track because some space is still available. However, after the file has been uploaded, the title will effectively have 6 MB of storage deficit. If the title tries to upload another piece of content, storage front door 230 will deny the requests until the title has deleted more than 6 MB of data from their title managed database.

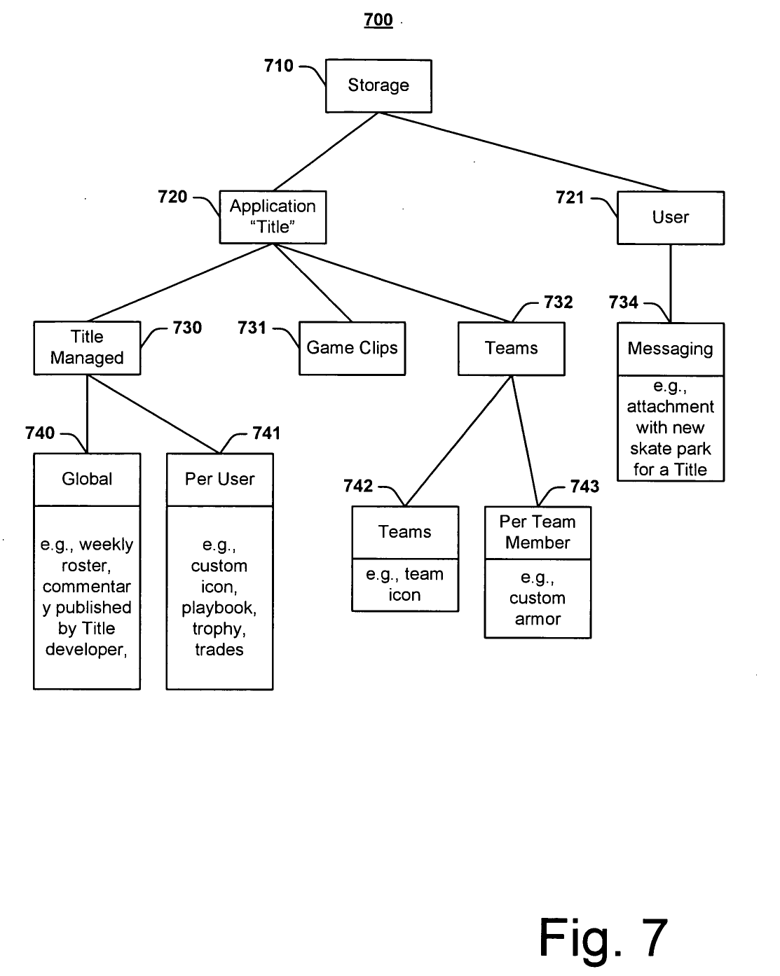

The systems and methods described in FIGS. 1 through 6 enable various multimedia and gaming scenarios. FIG. 7 shows one illustrative organization of databases 700. The highest level is the root level of storage 710. Storage 710 can be divided into user-managed databases 721 and particular multimedia application or “title”-managed databases 720.

User-managed databases 721 may include, for example, messaging database 734. Messaging database 734 may include, for example, an attachment sent from one multimedia application user to another user of the same multimedia application. In this manner, one user of a multimedia application, for example, a skateboard gaming application, may send a new skate park to another user of the skateboard gaming application. Messaging database 734 may also include voice-mails between user, e-mail between users, and the like.

Title-managed database 720 may be subdivided into title-managed database 730, game-clip database 731, and team database 732. Title-managed database 730 can be further divided into title global database 740 and title per-user database 741. Title per-user database 741 may provide storage space for each multimedia application title and also, for each user of each title. This allows a game title to store data that other gamers can access. For example, title per-user database 741 may store custom playbook/rosters, player emblems, logs of last played games, customization, game content, and the like. Additionally, title global database 740 may be updated by multimedia application publisher 290 with data that may be downloaded to various multimedia consoles 100 when the consoles access data center 210. For example, global database 740 may store trophies, awards, targeted messages, advertisements, balancing, and the like. In this manner, the title-managed, per-user storage provides a feature that allows the multimedia application title to store information on behalf of each user as well as storing global title information. A path to such information may be, for example, Storage, Game1, Player1, IconFile. Alternatively, user specific information could be stored on a per-user, per title basis. A path to such information may be, for example, Storage, Player1, Game1, IconFile.

This storage of data at data center 210 provides some additional functionality not available on stand-alone multimedia consoles. For example, a user may play a racing game and select particular game configuration settings via an options screen, such as, a suspension setting, a bike model, a bike color, and a riding suit color. The screen may then prompt if the game configuration settings should be stored on data center 210. If the user selects to store the settings on data center 210, the settings sent to data center 210 and stored, for example, in title per-user database 741. If the user then plays the racing game at his friend's house, the user can access title per-user database 741 and download his game configuration settings to the multimedia console at his friend's house.

The user may also store a special configuration for a gamepad controller of the multimedia console 100. For example, a left-handed user may set the gamepad controller configuration so that a key on the left side of the gamepad controller is used for jumping. If this “left-handed” configuration is stored on data center 210 (e.g., in database 741), the left-handed user may download this “left-handed” configuration to any networked multimedia console, regardless of geographic location.

Also, the multimedia application publisher may maintain a website for configuration of game parameters. With such a publisher maintained website, a user may, for example, login to the website and create a playbook for a football game. The user may also create fantasy rosters, custom emblems, and the like. This information may be sent by the multimedia publisher from their website to data center 210, for example, via security gateway 295 and be stored in database 741. These game parameters may be automatically downloaded to the user's multimedia console upon logging in to data center 210.

Further, the multimedia publisher may reward users with trophies, sponsorship for a racing car, a special paintjob for a racing car, and the like. The rewards may be globally unique so that other users can determine which users are good players.

Title global database 740 provides storage space for multimedia application publishers for each title. This allows the publisher to manage and publish content to be used by the multimedia consoles 100. In this manner, publishers may quickly update, change, and release game configuration data. For example, multimedia publishers may publish game configuration/quality of service (QoS)/play balancing and tuning files, advertisements, music, videos, updated game modes, updated challenges, news, tutorials, top screenshots, top stories, top game clips, commentary, persistent world data, updated rosters, special items in game (e.g., rare gun, sword, car weapon), and the like.

Some multimedia game parameters, such as, for example, match/QoS/game tuning settings are difficult to fine tune before release time. Publishers often guess how users will use the service. By sending new game tuning settings to title-global database 740, the publisher may get new settings into the multimedia console 100 and significantly improve the user's game experience quickly. Games may also have updated rosters, game text, and other time sensitive data downloaded to multimedia console 100.

To support the use of database 720 and 721, APIs (e.g., web widget API's) may be used to interface with database 740, as well as other databases of storage server(s) 232. The API's may include API's to request the amount of available space in a database, to enumerate files on storage server(s) 232, to transfer file(s) to the storage server(s) 232, retrieve files from the storage server(s) 232, to delete files from storage server(s) 232, to get quota information about space used/space remaining in storage server(s) 232.

Access to title-global database 740 may be classified into two categories: (1) access from within a multimedia application (e.g., game) and (2) access outside the context of the multimedia application (e.g., a multimedia application game publisher downloading a new parameter). The first scenario may be handled via client APIs. The second scenario may be accomplished by the use of a web API.

Users typically cannot directly access database 720; rather a user typically accesses database 720 through the multimedia application. That is, the multimedia application typically determines how and when users interact with the space.

A multimedia publisher may “clean up” content in title-global database 720 by deleting files, by setting an expiration date for content, and the like. The expiration date may be in a delta form, such as, for example, days from when the data was last accessed or touched.

Aspects of the invention may be implemented via computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It should be noted that although the multimedia console discussed herein is described as a dedicated multimedia console (not a general-purpose PC running computer games), the multimedia console may also incorporate additional functionality. For example, the multimedia console may include digital video recording functionality so that it can operate as a digital VCR, the multimedia console may include channel tuning functionality so that it can tune and decode television signals (whether they be broadcast signals, cable signals, satellite signals, etc.), and so forth. Further, in alternate embodiments, the multimedia console is replaced with a set top box or other computing device.

As the foregoing illustrates, the invention is directed to providing data management for a networked console. Such management may include title managed storage that may provide an extensible platform for multimedia (e.g., game) publishers to create fresh, new, compelling experiences. It is understood that changes may be made to the illustrative embodiments described above without departing from the broad inventive concepts disclosed herein. Accordingly, it is understood that the invention is not limited to the particular embodiments disclosed, but is intended to cover all modifications that are within the spirit and scope of the invention as defined by the appended claims.

1. A system for managing data accessible by a plurality of multimedia consoles each capable of executing a multimedia application, the system comprising:
a multimedia application database that stores data for the plurality of multimedia consoles;
a storage manager in communication with the plurality of multimedia consoles and the database, the storage manager receives a request from at least one of the plurality of multimedia consoles for communicating data with the database and determines whether to grant the request;
a storage configuration database in communication with the storage manager that stores access permission information for the database;
wherein the storage manager determines whether to grant the request based at least in part on the access permission information.

2. The system as recited in claim 1, wherein the multimedia application database does not include access permission information.

3. The system as recited in claim 1, wherein the multimedia application database includes a plurality of databases and wherein the storage configuration database stores access permission information for each of the plurality of databases.

4. The system as recited in claim 1, wherein the plurality of multimedia consoles has an associated plurality of multimedia console users and wherein the access permission information comprises access permission information associated with each of the plurality of multimedia console users.

5. The system as recited in claim 1, wherein the plurality of multimedia consoles has an associated plurality of pre-titled multimedia applications executable on the plurality of multimedia consoles and wherein the access permission information comprises access permission information associated with each multimedia application title.

6. The system as recited in claim 1, wherein the storage configuration database stores quota information regarding the size of structures for storing data in the multimedia application database.

7. The system as recited in claim 6, wherein the storage manager determines whether to grant the request based on the quota information.

8. The system as recited in claim 1, wherein the multimedia application database stores data for the plurality of multimedia consoles in a file format.

9. The system as recited in claim 1, wherein the multimedia application database stores data for the plurality of multimedia consoles in a slot format, whereby multimedia applications files may extend over multiple slots.

10. The system as recited in claim 1, further comprising a security gateway in communication between the plurality of multimedia consoles and the storage manager wherein the security gateway provides authentication and security.

11. The system as recited in claim 10, wherein the authentication comprises authentication of at least one of the plurality of multimedia consoles and authentication of a user of at least one of the multimedia consoles.

12. The system as recited in claim 10, wherein the security comprises encryption and decryption of communication between the plurality of multimedia consoles and the security gateway.

13. The system as recited in claim 10, further comprising a second security gateway reserved for communication between the storage manager and a publisher of a multimedia application executable on the plurality of multimedia consoles and wherein the second security gateway provides authentication and security.

14. The system as recited in claim 1, wherein the plurality of multimedia consoles have an associated plurality of multimedia console users, the plurality of multimedia consoles have an associated plurality of pre-titled multimedia applications executable on the plurality of multimedia consoles, and wherein the multimedia application database comprises:
a database that stores messages between the plurality of multimedia console users.

15. The system as recited in claim 1, wherein the plurality of multimedia consoles have an associated plurality of multimedia console users, the plurality of multimedia consoles have an associated plurality of pre-titled multimedia applications executable on the plurality of multimedia consoles, and wherein the multimedia application database comprises:
a first database that stores data managed by the plurality of multimedia console users; and
a second database that stores data managed on behalf of one of the pre-titled multimedia applications.

16. The system as recited in claim 1, wherein the plurality of multimedia consoles have an associated plurality of multimedia console users, the plurality of multimedia consoles have an associated plurality of pre-titled multimedia applications executable on the plurality of multimedia consoles, and wherein the multimedia application database comprises:
a database that stores data managed on behalf of the multimedia application title wherein at least a portion of the data is associated with a time which the at least a portion of the data is deleted.

17. The system as recited in claim 1, wherein the plurality of multimedia consoles have an associated plurality of pre-titled multimedia applications executable on the plurality of multimedia consoles, each of the plurality of pre-titled multimedia applications has an associated plurality of multimedia console users, and wherein the multimedia application database comprises:
a database that stores data segregated by each multimedia application title and associated with each segregation of data by multimedia application title, stores data segregated by each of the plurality of multimedia console users associated with the multimedia application title.

18. The system as recited in claim 1, wherein the plurality of multimedia consoles have an associated plurality of pre-titled multimedia applications executable on the plurality of multimedia consoles, each of the plurality of pre-titled multimedia applications has an associated plurality of multimedia console users, and wherein the multimedia application database comprises:
a database that stores data segregated by each user of the plurality of multimedia application console users and associated with each segregation of data by user, stores data segregated by each of the plurality of pre-titled multimedia applications.

19. The system as recited in claim 1, wherein the plurality of multimedia consoles have an associated plurality of pre-titled multimedia applications executable on the plurality of multimedia consoles, each of the plurality of pre-titled multimedia applications has an associated plurality of multimedia console users, each associated plurality of multimedia console users comprises a subset of users that are associated with a multimedia application title and that function as a team of the multimedia application title, and wherein the multimedia application database comprises:
a database that stores data segregated by each team and associated with each segregation of data by team, stores data segregated by each user of the team.

20. A method for managing data for a network of multimedia consoles each executing a multimedia application, the method comprising:
receiving, at a storage manager in communication with a multimedia application database that stores data for the plurality of multimedia consoles, a data request for accessing the multimedia application database from a multimedia console;
determining, from a storage configuration database separate from the multimedia application database, an access permission information associated with the multimedia application database; and
determining whether to grant the request based at least in part on the access permission information.

21. The method as recited in claim 20, wherein the multimedia application database does not include access permission information.

22. The method as recited in claim 20, further comprising downloading the access permission information from the storage configuration database.

23. The method as recited in claim 20, further comprising:
determining a requestor and a request type associated with the request; and wherein
determining whether to grant the request comprises determining whether to grant the request based at least in part on the requestor and the request type.

24. The method as recited in claim 20, wherein the multimedia application database includes a plurality of databases and wherein the storage configuration database stores access permission information for each of the plurality of databases.

25. The method as recited in claim 20, wherein the plurality of multimedia consoles has an associated plurality of multimedia console users and wherein the access permission information comprises access permission information associated with each of the plurality of multimedia console users.

26. The method as recited in claim 20, wherein the plurality of multimedia consoles has an associated plurality of pre-titled multimedia applications executable on the plurality of multimedia consoles and wherein the access permission information comprises access permission information associated with each multimedia application title.

27. The method as recited in claim 20, wherein the storage configuration database stores quota information regarding the size of structures for storing data in the multimedia application database.

28. The method as recited in claim 27, wherein determining whether to grant the request comprises determining whether to grant the request based at least in part on the quota information.

29. The method as recited in claim 20, wherein the multimedia application database stores data for the plurality of multimedia consoles in a file format.

30. The method as recited in claim 20, wherein the multimedia application database stores data for the plurality of multimedia consoles in a slot format, whereby multimedia applications files may extend over multiple slots.

31. The method as recited in claim 20, further comprising authenticating the request.

32. The method as recited in claim 31, wherein authenticating the request comprises authenticating a multimedia console of the plurality of multimedia consoles associated with the request and authenticating a user of the multimedia console of the plurality of multimedia consoles associated with the request.

33. The method as recited in claim 31, further comprising encrypting and decrypting communication with the plurality of multimedia consoles.

34. The method as recited in claim 31, further comprising receiving a data request at a security gateway reserved for communication between the storage manager and a publisher of a multimedia application executable on the plurality of multimedia consoles.

35. The method as recited in claim 20, wherein the plurality of multimedia consoles have an associated plurality of multimedia console users, the plurality of multimedia consoles have an associated plurality of pre-titled multimedia applications executable on the plurality of multimedia consoles, and wherein the multimedia application database comprises a database that stores messages between the plurality of multimedia console users, the method further comprising:
determining that the request is associated with the database that stores messages between the plurality of multimedia console users; and
sending the data request to the database that stores messages between the plurality of multimedia console users.

36. The method as recited in claim 20, wherein the plurality of multimedia consoles have an associated plurality of multimedia console users, the plurality of multimedia consoles have an associated plurality of pre-titled multimedia applications executable on the plurality of multimedia consoles, and wherein the multimedia application database comprises a first database that stores data managed by the plurality of multimedia console user; and a second database that stores data managed on behalf of one of the pre-titled multimedia applications, the method further comprising:
determining whether the request is associated with the first database or the second database; and
sending the data request to the database associated with the request.

37. The method as recited in claim 20, wherein the plurality of multimedia consoles have an associated plurality of pre-titled multimedia applications executable on the plurality of multimedia consoles, each of the plurality of pre-titled multimedia applications has an associated plurality of multimedia console users, and wherein the multimedia application database comprises a database that stores data segregated by each multimedia application title and associated with each segregation of data by multimedia application title, stores data segregated by each of the plurality of multimedia console users associated with the multimedia application title, the method further comprising:
determining that the request is associated with the database that stores data segregated by each multimedia application title; and
sending the data request to the database that stores data segregated by each multimedia application title.

38. The method as recited in claim 20, wherein the plurality of multimedia consoles have an associated plurality of pre-titled multimedia applications executable on the plurality of multimedia consoles, each of the plurality of pre-titled multimedia applications has an associated plurality of multimedia console users, and wherein the multimedia application database comprises a database that stores data segregated by each user and associated with each segregation of data by each user, stores data segregated by each multimedia application title, the method further comprising:
determining that the request is associated with the database that stores data segregated by each user; and
sending the data request to the database that stores data segregated by each user.

39. The method as recited in claim 20, wherein the plurality of multimedia consoles have an associated plurality of pre-titled multimedia applications executable on the plurality of multimedia consoles, each of the plurality of pre-titled multimedia applications has an associated plurality of multimedia console users, each associated plurality of multimedia console users comprises a subset of users that are associated with a multimedia application title and that function as a team of the multimedia application title, and wherein the multimedia application database comprises a database that stores data segregated by each team and associated with each segregation of data by team, stores data segregated by each user of the team, the method further comprising:
determining that the request is associated with the database that stores data segregated by each team; and
sending the data request to the database that stores data segregated by each team.

40. A method for data management of data accessible by a plurality of multimedia consoles each capable of executing a multimedia application, wherein the plurality of multimedia consoles have an associated plurality of pre-titled multimedia applications executable on the plurality of multimedia consoles, the method comprising:
receiving a data request from a multimedia console;
parsing the data request into:
a first field representative of a data center associated with the data;
a second field representative of a multimedia application title;
determining whether to grant the request; and
sending the request to a multimedia application database associated with the multimedia application title.

41. The method as recited in claim 40, wherein each of the plurality of pre-titled multimedia applications has an associated plurality of multimedia console users, and wherein:
parsing the data request further comprises parsing the data request into a third field representative of a user; and
sending the request to the multimedia application database further comprises sending the request to a multimedia application database associated with the multimedia application title and associated with the user.

42. The method as recited in claim 40, wherein each of the plurality of pre-titled multimedia applications has an associated plurality of multimedia console users, each associated plurality of multimedia console users comprises a subset of users that are associated with a multimedia application title and that function as a team for the multimedia application title and wherein:
parsing the data request further comprises parsing the data request into a third field representative of a team; and
sending the request to the multimedia application database further comprises sending the request to a multimedia application database associated with the multimedia application title and associated with the team.

43. The method as recited in claim 40, further comprising:
determining a requestor and a request type associated with the request; and
determining whether to grant the request based at least in part on the requestor and the request type.
